(19) United States
(12) Patent Application Publication
(10) Pub. No.: US 2017/0227123 A1
(43) Pub. Date: Aug. 10, 2017

(54) Method for Adaptive Ratio Control and Diagnostics in a Ball Planetary Type Continously Variable Transmission

(71) Applicant: Dana Limited, Maumee, OH (US)

(72) Inventors: Jeffrey M David, Cedar Park, TX (US); Thomas Neil McLemore, Georgetown, TX (US)

(21) Appl. No.: 15/424,528

(22) Filed: Feb. 3, 2017

Related U.S. Application Data
(60) Provisional application No. 62/291,635, filed on Feb. 5, 2016.

(51) Int. Cl. F16H 61/664

(52) U.S. Cl. CPC F16H 61/6647; F16H 15/503

(57) ABSTRACT

Provided herein is a control system for a multiple-mode continuously variable transmission having a ball planetary variator. The control system has a transmission control module configured to receive a plurality of electric input signals, and to determine a mode of operation from plurality of control ranges based at least in part on the plurality of electronic input signals. The system also has an adaptive ratio control module configured to store at least one calibration map, and configured to determine an adaptive speed ratio command signal during operation of the CVP.

### RELATED APPLICATION

This application claims the benefit of U.S. Provisional Application No. 62/291,635 filed on Feb. 5, 2016, which is herein incorporated by reference.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations could, for example, multiply input torque across the different transmission stages in different manners to achieve the same final drive ratio. However, some configurations provide more flexibility or better efficiency than other configurations providing the same final drive ratio.

The criteria for optimizing transmission control are different for different applications of the same transmission. For example, the criteria for optimizing control of a transmission for fuel efficiency will differ based on the type of prime mover applying input torque to the transmission. Furthermore, for a given transmission and prime mover pair, the criteria for optimizing control of the transmission will differ depending on whether fuel efficiency or performance is being optimized

### SUMMARY

Provided herein is a computer-implemented system for a vehicle having an engine coupled to a continuously variable transmission having a ball-planetary variator (CVP), the computer-implemented system including: a digital processing device including an operating system configured to perform executable instructions and a memory device; a computer program including instructions executable by the digital processing device to create an application including a software module configured to manage a plurality of vehicle driving conditions; a plurality of sensors configured to monitor vehicle parameters including: CVP Speed Ratio, CVP Input Torque, CVP position, wherein the software module is configured to execute a ratio-to-position adaptive control sub-module, wherein the ratio-to-position adaptive control sub-module includes a first ratio-to-position calibration table configured to store values of a CVP position based at least in part on the CVP input torque and the CVP speed ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the embodiments are utilized, and the accompanying drawings of which:

FIG. 1 is a side sectional view of a ball-type variator.

FIG. 2 is a representative plan view of a carrier member that is used in the variator of FIG. 1.

FIG. 3 is an illustrative view of different tilt positions of the ball-type variator of FIG. 1.

FIG. 4 is a representative block diagram schematic of a transmission control system that is implemented in a vehicle.

FIG. 5 is a block diagram schematic of a speed ratio control sub-module that is implemented in the transmission control system of FIG. 4.

FIG. 6 is a block diagram schematic of an adaptive ratio control sub-module that is implemented in the speed ratio control sub-module of FIG. 5.

FIG. 7 is a block diagram schematic of an adaptive enabled sub-module that is implemented in the adaptive ratio control sub-module of FIG. 6.

FIG. 8 is a block diagram schematic of a short-term adaptive control sub-module that is implemented in the adaptive ratio control sub-module of FIG. 7.

FIG. 9 is a block diagram schematic of a long-term adaptive control sub-module that is implemented in the adaptive ratio control sub-module of FIG. 7.

FIG. 10 is a block diagram schematic of a diagnostic sub-module that is implemented in the adaptive ratio control sub-module of FIG. 7.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller could be configured to receive input signals indicative of parameters associated with an engine coupled to the transmission. The parameters could include throttle position sensor values, accelerator pedal position sensor values, vehicle speed, gear selector position, user-selectable mode configurations, and the like, or some combination thereof. The electronic controller could also receive one or more control inputs. The electronic controller could determine an active range and an active variator mode based on the input signals and control inputs. The electronic controller could control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. Pat. application Ser. No. 14/425,842, entitled “3-Mode Front Wheel Drive And Rear Wheel Drive Continuously Variable Planetary Transmission” and, U.S. Patent Application No. 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather could be configured to control any of several types of variable ratio transmissions.

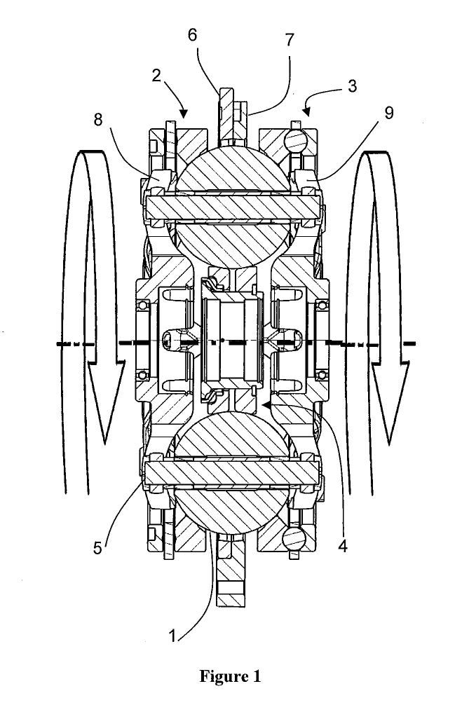

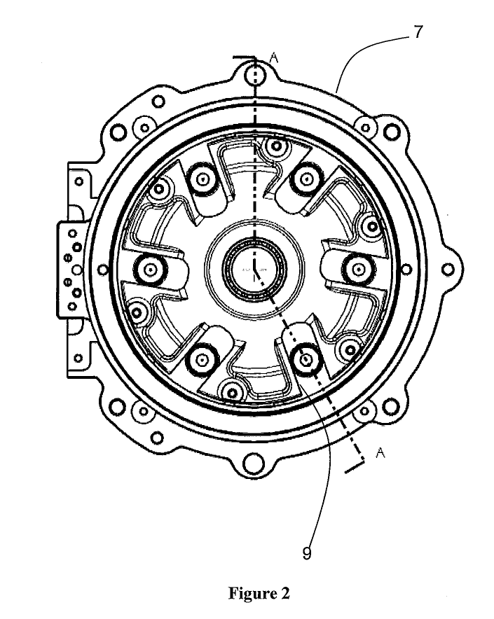

Provided herein are configurations of CVTs based on a ball type variators, also known as CVP, for continuously variable planetary. Basic concepts of a ball type Continuously Variable Transmissions are described in U.S. Pat. No. 8,469,856 , and U.S. Pat. No. 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input traction ring 2 and output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

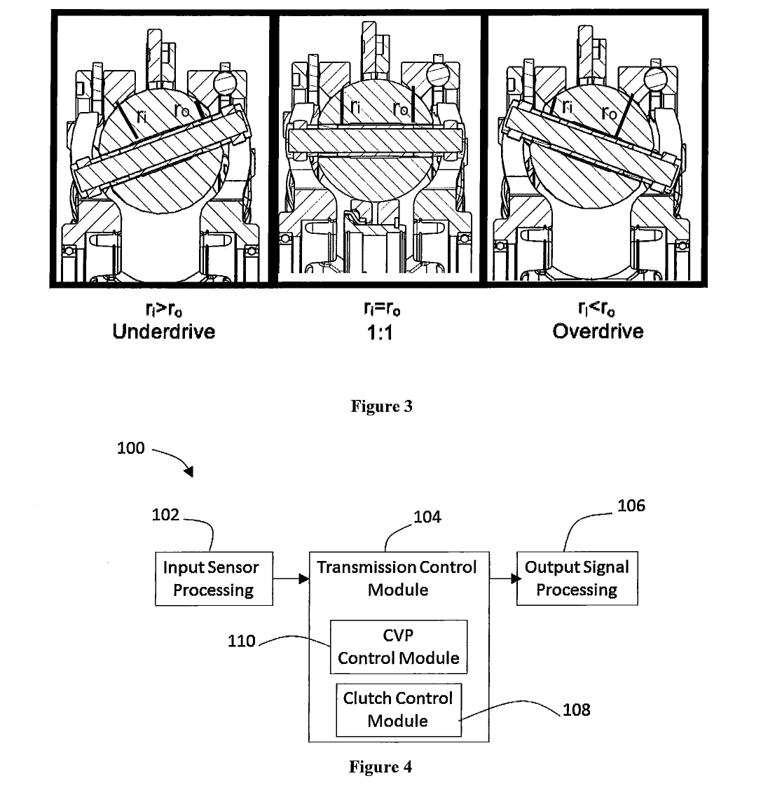

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “torque threshold” is used here to indicate a calibratable value of torque at which a designer desires a control sub-module to enable operation or dis-able operation.

As used herein, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial” is used herein to indicate a direction or position that is perpendicular relative to a longitudinal axis of a transmission or variator. The term “axial” as used herein refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives herein, generally these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (n) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described herein could operate in both tractive and frictional applications. As a general matter, the traction coefficient pi is a function of the traction fluid properties, the normal force at the contact area, and the velocity of the traction fluid in the contact area, among other things. For a given traction fluid, the traction coefficient n increases with increasing relative velocities of components, until the traction coefficient n reaches a maximum capacity after which the traction coefficient n decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source could be fueled by energy sources including hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission including this technology.

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the IVT includes a processor (not shown).

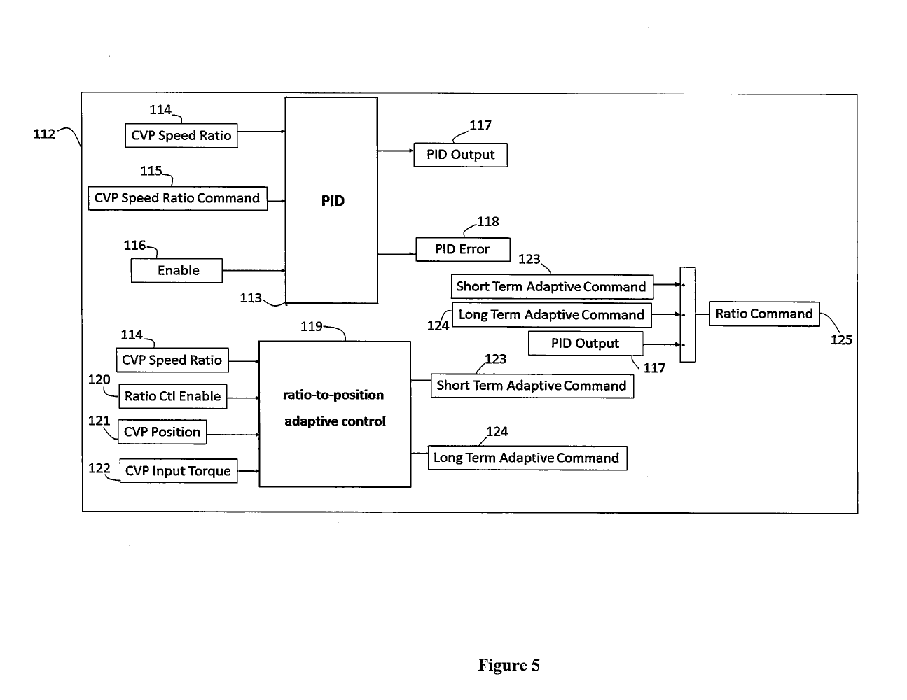

Referring now to FIG. 4, in one embodiment, a transmission controller 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed herein. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed herein. It should be noted that the CVP control sub-module 110 optionally incorporates a number of sub-modules for performing measurements and control of the CVP. One sub-module included in the CVP control sub-module 110 is described herein.

Referring now to FIG. 5, in one embodiment, the CVP control sub-module 110 includes a speed ratio control sub-module 112. The speed ratio control sub-module 112 includes a PID sub-module 113 adapted to receive a CVP speed ratio signal 114, a commanded CVP ratio signal 115, and an enabled signal 116. In one embodiment, the CVP speed ratio signal 114 is acquired from sensors equipped on the CVP and the CVP speed ratio signal 114 is indicative of a speed ratio at which the CVP is currently operating. In one embodiment, the commanded CVP ratio signal 115 is determined in another sub-module of the CVP control sub-module 110 and the commanded CVP ratio signal 115 is indicative of a desired ratio for the CVP. The enabled signal 116 is determined by another sub-module of the CVP control sub-module 110 and provides a true or false indicator for the PID sub-module 113 to run. Typically, a PID controller, otherwise known as a proportional-integral-derivative controller, is configured for receiving a difference between a set point and a controlled variable of a process to be controlled and delivering a manipulated variable to the process, the process being operated by the manipulated variable to produce the controlled variable. The PID sub-module 113 determines a PID output signal 117 and an error signal 118. The PID output signal 117 is indicative of a control signal for the associated CVP actuators. The error signal 118 is associated with the difference between the commanded CVP ratio signal 115 and the CVP speed ratio signal 114.

In one embodiment, the speed ratio control sub-module 112 includes a ratio-to-position adaptive control sub-module 119 configured to receive the CVP ratio signal 114, a ratio control enabled signal 120, a CVP position signal 121, and a CVP input torque signal 122. The CVP input torque signal 122 is received from other sub-modules in the transmission control module 104 and is indicative of an input torque magnitude applied to the CVP. The ratio control enabled signal 120 is received from other sub-modules in the transmission control module 104 and is indicative of an operating state where the CVP speed ratio is that feedback for control. The CVP position signal 121 is indicative of a shift position of the CVP. In some embodiments, the shift position of the CVP corresponds to a position of the first carrier member 6 with respect to the second carrier member 7, for example. It should be noted that the embodiments disclosed herein are directed to a control method using shift position of the CVP as a control parameter. In other embodiments, a shift force of the CVP is optionally used in place of the position of the CVP in the control methods disclosed herein. For example, a shift force of the CVP is provided by the shift actuator. In some embodiments, the shift actuator is a hydraulic device. In other embodiments, the shift actuator is an electronic device having a motor. In yet other embodiments, the shift actuator is an electro-hydraulic device. In one embodiment, the ratio-to-position adaptive control sub-module 119 determines a short-term adaptive command signal 123 and a long-term adaptive command signal 124. The short-term adaptive command signal 123, the long-term adaptive command signal 124, and the PID output signal 117 are summed to form a ratio control command signal 125. The ratio control command signal 125 is passed to other sub-modules of the transmission control module 104 are used to adjust actuators equipped on the CVP.

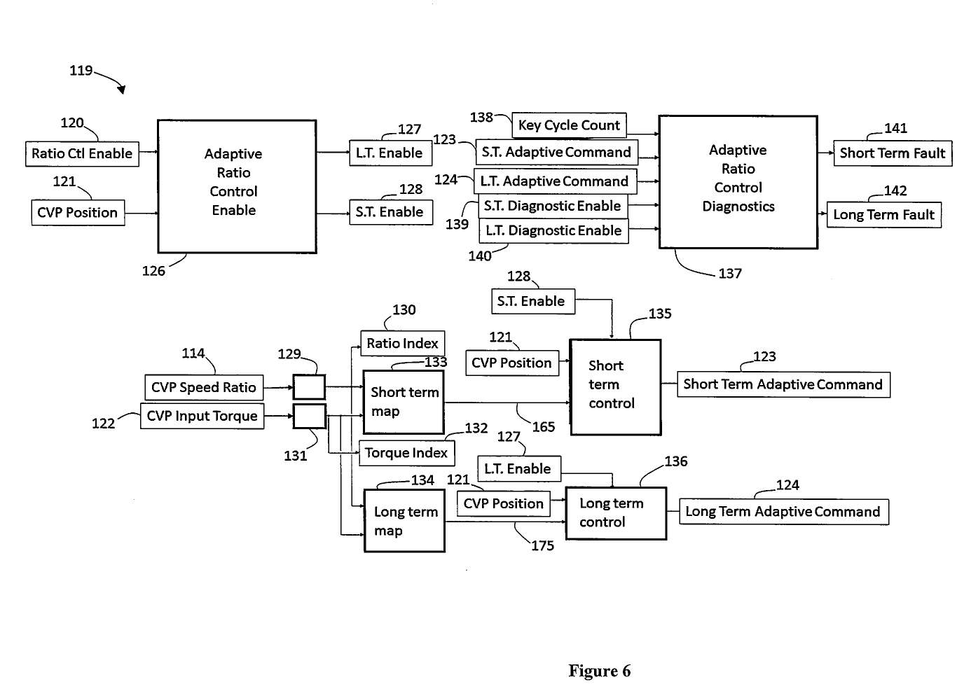

Referring now to FIG. 6, in one embodiment, the ratio-to-position adaptive control sub-module 119 is configured to provide adaptive speed ratio control during operation of the CVP in order to enhance the performance of the transmission control module 104. As used herein, the terms “adaptive” or “adaptive control” refers to a method of estimating control and/or calibration parameters during operations based on measured signals. The ratio-to-position adaptive control sub-module 119 receives the CVP speed ratio signal 114, the CVP input torque signal 122, and a CVP position signal 121. The ratio-to-position adaptive control sub-module 119 includes an adaptive ratio control enabled sub-module 126 configured to receive the ratio control enabled signal 120 and the CVP position signal 121. The adaptive ratio control enabled sub-module 126 determines a long-term adaptive control enabled signal 127 and a short-term adaptive control enabled signal 128 based at least in part on the ratio control enabled signal 120 and the CVP position signal 121. In one embodiment, the ratio-to-position adaptive control sub-module 119 includes a first ratio-to-position calibration table 129 configured to determine a ratio index signal 130 based at least in part on the CVP ratio signal 114. The ratio index signal 130 is indicative of a row position and an interpolation fraction for a calibration map. The ratio-to-position adaptive control sub-module 119 includes a second ratio-to-position calibration table 131 configured to determine a torque index signal 132 based at least in part on the CVP input torque signal 122. The torque index signal 132 is indicative of a column position and an interpolation fraction for a calibration map. The ratio index signal 130 and the torque index signal 132 are passed to a short-term adaptive control calibration map 133 and a long-term adaptive control calibration map 134. The short-term adaptive control calibration map 133 passes a command signal to a short-term ratio to position control sub-module 135 that determines the short-term adaptive command signal 123. The long-term adaptive control calibration map 134 passes a command signal to a long-term ratio to position control sub-module 136 that determines the long-term adaptive command signal 124. In one embodiment, the ratio-to-position adaptive control sub-module 119 includes an adaptive ratio control diagnostics sub-module 137. The adaptive ratio control diagnostic sub-module 137 is configured to receive the short-term adaptive command signal 123, the long-term adaptive command signal 124, a key cycle counter signal 138, a short-term adaptive diagnostic enabled signal 139, and a long-term adaptive diagnostic enabled signal 140. In one embodiment, the key cycle counter signal 138 is associated with a cumulative count of the “key-on” events, or the number of times the vehicle is turned on for operation. In one embodiment, the short-term adaptive diagnostic enabled signal 139 and the long-term adaptive diagnostic enabled signal 140 are calibratable signals configured to be read from memory. The adaptive ratio control diagnostic sub-module 137 is configured to determine a short-term fault signal 141 and a long tern fault signal 142.

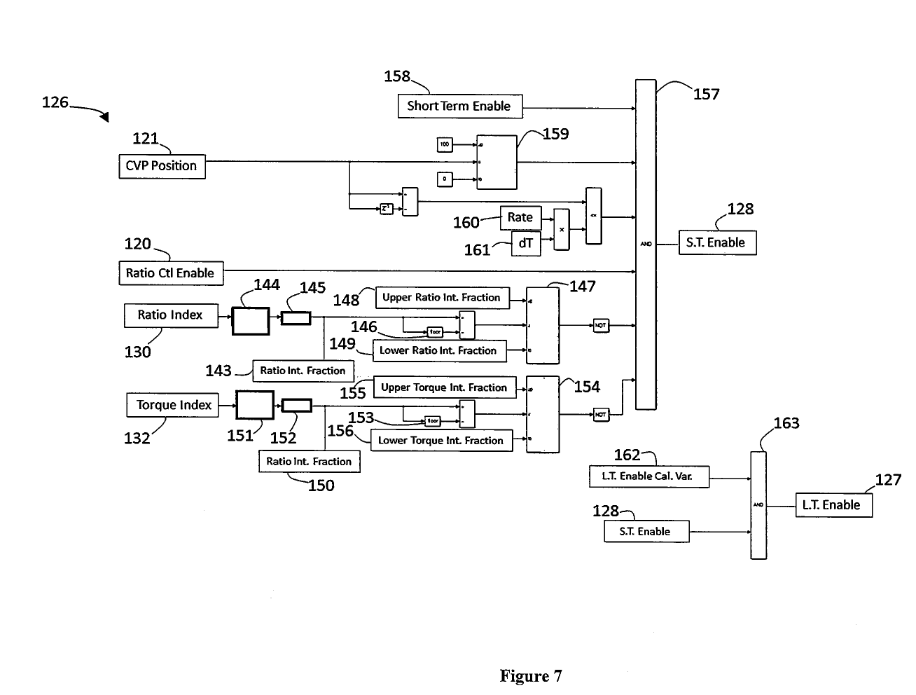

Referring now to FIG. 7, in one embodiment, the adaptive ratio control enabled sub-module 126 is configured to determine a ratio interpolation fraction 143 based at least in part on the ratio index signal 130 and a first data conversion block 144 and a second data conversion block 145. In one embodiment, the ratio interpolation fraction 143 is passed to a first floor function block 146 that passes the decimal portion of the ratio interpolation fraction signal 143 to a first evaluation block 147. The first evaluation block 147 receives a first calibration variable 148 indicative of an upper threshold for the ratio interpolation fraction signal 143. The first evaluation block 147 receives a second calibration variable 149 indicative of a lower threshold for the ratio interpolation fraction signal 143. The first evaluation block 147 passes a true signal if the result determined in the first floor function block 146 is between the first calibration variable 148 and the second calibration variable 149. In one embodiment, the adaptive ratio control enabled sub-module 126 is configured to determine a torque ratio interpolation fraction 150 based at least in part on the torque index signal 132 and a third data conversion block 151 and a fourth data conversion block 152. In one embodiment, the torque ratio interpolation fraction 150 is passed to a second floor function block 153 that passes the decimal portion of the torque interpolation fraction signal 150 to a second evaluation block 154. The second evaluation block 154 receives a third calibration variable 155 indicative of an upper threshold for the torque interpolation fraction signal 150. The second evaluation block 154 receives a fourth calibration variable 156 indicative of a lower threshold for the torque interpolation fraction signal 150. The second evaluation block 154 passes a true signal if the result determined in the second floor function block 153 is between the third calibration variable 155 and the fourth calibration variable 156. As used herein, the first data conversion block 144 and the third data conversion block 151 refers to well-known software implemented processes that convert the index signals to double precision floating point numbers. The second data conversion block 145 and the fourth conversion block 152 refers to well-known software implemented processes that convert double precision point floating numbers to single precision floating point numbers. It should be appreciated, that a designer optionally configures data conversion blocks to suit selected software and hardware implementations of the adaptive ratio control enabled sub-module 126. As used herein, the first floor function block 146 and the second floor function block 153 refer to a well-known software implemented mathematical function configured to associate a real number to the largest previous or the smallest following integer. Stated differently, the first floor function block 146 and the second floor function block 153 pass the next nearest integer or whole number value of the ratio interpolation fraction signal 143 and the torque interpolation fraction signal 150, respectively.

Still referring to FIG. 7, in one embodiment, the adaptive ratio control enabled sub-module 126 includes a first Boolean block 157 configured to receive the inverse of the resulting signals from the first evaluation block 147 and the second evaluation block 154. The first Boolean block 157 receives a short-term enabled signal 158. In one embodiment, the short-term enabled signal 158 is a calibratable signal configured to be read from memory. The first Boolean block 157 receives a signal determined in a third evaluation block 159. The third evaluation block 159 is configured to compare the CVP position signal 121 to an upper and lower threshold. If the CVP position signal 121 is between the upper and lower threshold values, the third evaluation block 159 passes a true signal (or a “1” value) to the first Boolean block 157. In one embodiment, the adaptive ratio control enabled sub-module 126 determines a rate of change of the CVP position signal 121 by taking a difference between the current signal and the signal from the previous time step and comparing it to a product of a rate calibration signal 160 and a time step signal 161. If the rate of change of the CVP position signal 121 is less than the product of the rate calibration signal 160 and the time step signal 161, a true signal (or a “1” value) is passed to the Boolean block 157. The first Boolean block 157 evaluates the received signals to determine the short-term adaptive control enabled signal 128. In one embodiment, the adaptive ratio control enabled sub-module 126 is configured to receive a long-term enabled calibration variable 162 that is passed to a second Boolean block 163. The second Boolean block 163 evaluates the long-term enabled calibration variable 162 and the short-term adaptive control enabled signal 128. If both signals have true values, the second Boolean block 163 returns a true signal for the long-term adaptive control enabled signal 127.

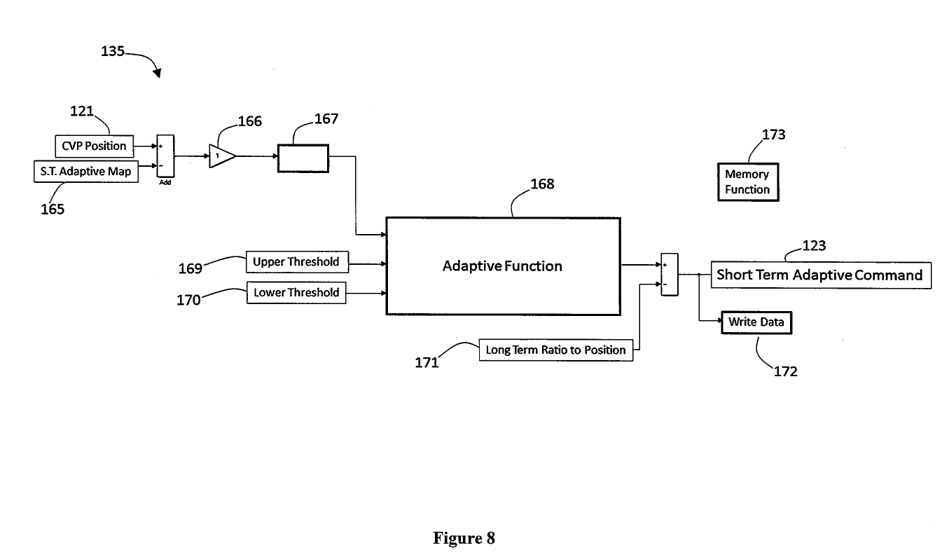

Referring now to FIG. 8, in one embodiment, the short-term ratio to position control sub-module 135 is configured to determine a difference between the CVP position signal 121 and a short-term adaptive map signal 165. The short-term adaptive map signal 165 is the result of the short-term adaptive control calibration map 133 (FIG. 6). The difference between the short-term adaptive map signal 165 and the CVP position signal 121 is passed through a calibratable gain 166. The calibratable gain 166 is provided to enable designers to tune the short-term ratio to position control sub-module 135. The resulting signal is passed through a data conversion block 167 to form a single precision floating point number to be used in an adaptive function block 168. The adaptive function block 168 is a software implementable algorithm for a well-known adaptive control routine. The adaptive function block 168 receives a first calibratable variable 169 and a second calibratable variable 170. The first calibratable variable 169 and the second calibratable variable 170 are indicative of a lower threshold and an upper threshold for the appropriate range of the single precision floating point number determined by the data conversion block 167. The short-term adaptive command signal 123 is formed by the difference between the resulting signal determined in the adaptive function block 168 and a long-term ratio-to-position signal 171. In one embodiment, the long-term ratio-to-position signal 171 is read from stored memory, for example, from values written to memory during a previous key-on cycle based on the key cycle counter signal 138. In one embodiment, the short-term adaptive command signal 123 is passed to a write data function block 172 configured to write the short-term adaptive command signal 123 to memory. In one embodiment, the short-term ratio to position control sub-module 135 includes a function block 173. The function block 173 is used to explicitly declare a volatile memory region to store the short-term adaptive map signal 165. As used herein, the term volatile refers to data reset to 0 across controller power cycles from on to off.

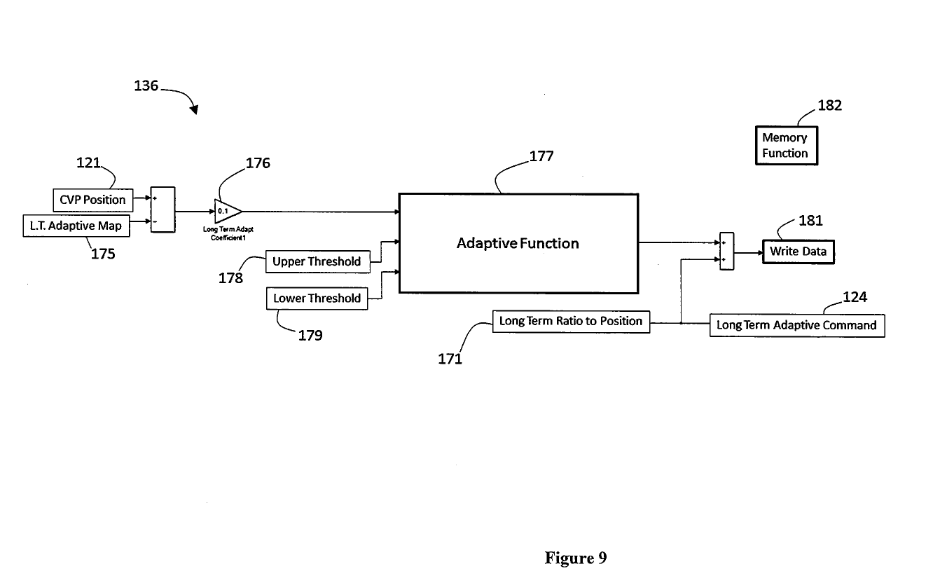

Referring now to FIG. 9, in one embodiment, the long-term ratio to position control sub-module 136 is configured to determine a difference between the CVP position signal 121 and a long-term adaptive map signal 175. The long-term adaptive map signal 175 is the result of the long-term adaptive control calibration map 134 (FIG. 6). The difference between the long-term adaptive map signal 175 and the CVP position signal 121 is passed through a calibratable gain 176. The calibratable gain 176 is provided to enable designers to tune the long-term ratio to position control sub-module 136. The resulting signal is passed to an adaptive function block 177. The adaptive function block 177 is a software implementable algorithm for a well-known adaptive control routine. The adaptive function block 177 receives a first calibratable variable 178 and a second calibratable variable 179. The first calibratable variable 178 and the second calibratable variable 179 are indicative of a lower threshold and an upper threshold for the appropriate range of the single precision floating point number determined by the calibratable gain 176. The resulting signal determined in the adaptive function block 177 is summed with the long-term ratio-to-position signal 124 and passed to a write function 181. In one embodiment, the long-term ratio-to-position signal 124 is read from memory at a read function block 171. In one embodiment, the long-term ratio to position control sub-module 136 includes a function block 182. The function block 182 is used to explicitly declare a volatile memory region to store the long-term adaptive map signal 175. As used herein, the term volatile refers to data reset to 0 across controller power cycles from on to off.

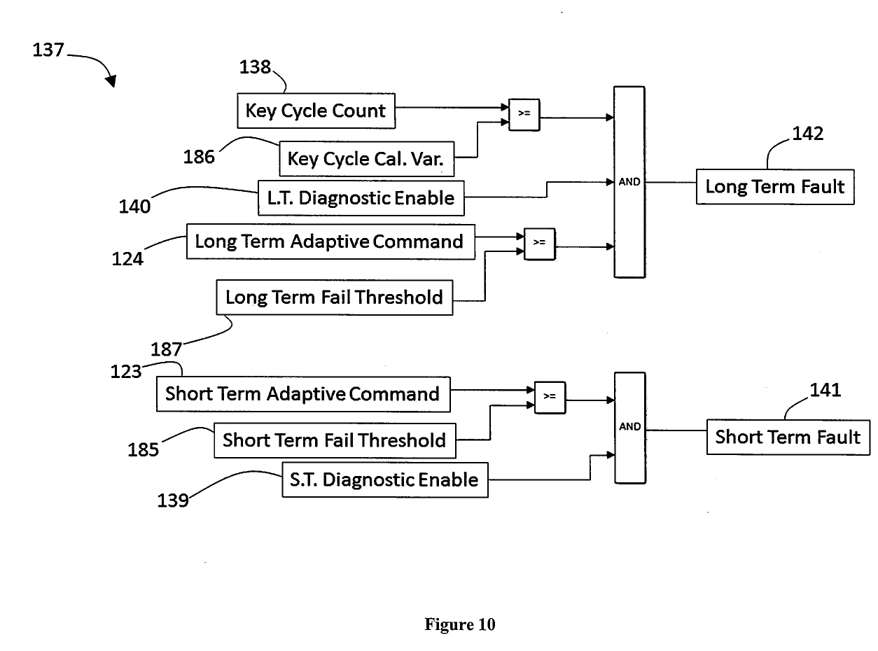

Referring now to FIG. 10, in one embodiment, the adaptive ratio control diagnostic sub-module 137 is configured to receive the short-term adaptive command signal 123, the long-term adaptive command signal 124, a key cycle counter signal 138, a short-term adaptive diagnostic enabled signal 139, and a long-term adaptive diagnostic enabled signal 140. The adaptive ratio control diagnostic sub-module 137 is configured to determine a short-term fault signal 141 and a long-term fault signal 142. The short-term fault signal 141 returns a true condition (or a “1” signal) if the following conditions are true: the short-term adaptive command signal 123 is greater than or equal to a short-term fail threshold calibration variable 185 and the short-term adaptive diagnostic enabled signal 139 is true. The long-term fault signal 142 returns a true condition (or a “1” signal) if the following conditions are true: the key cycle counter signal 138 is greater than or equal to a key cycle calibration variable 186, the long-term adaptive diagnostic enabled signal 140 is true, and the long-term adaptive command signal 123 is greater than or equal to a long-term fail threshold calibration variable 187. In some embodiments, additional diagnostic enabled criteria is optionally provided such that no related speed sensor, actuator, or position sensor faults exist that could render the adaptive diagnostics subject to false fail.

During normal operation of the CVP, the short-term ratio to position control sub-module 135 is expected to track the required deviation from the commanded speed ratio signal 114 to the short-term adaptive command signal 123 that is necessary to maintain desirable CVP speed ratio control. Over time these short-term corrections are learned by the long-term ratio to position control sub-module 136. Once the long-tern ratio to position control sub-module 136 has learned the characteristics of the CVP it is expected that the short-term adaptive command signals 123 will be sufficiently small such that any large deviations in the short-term adaptive command signals 123 are reflective of a real time gross slip condition. During operation of the CVP, the short-term fault signal 141 is thus optionally used to diagnose a slip condition of the CVP. Optionally, the short-term diagnostic failure detection can be used as an input into a torque remediation strategy to reduce the impact of sudden gross slip. Over time the performance of the CVP may slowly decline such that progressively larger adaptive values, for example the short-term adaptive command signal 123, are learned by the long-term ratio to position control sub-module 136 in order to keep the short-term adaptive command signal 123 near zero. Consequently, the long-term adaptive command signal 124 will reflect the changing performance conditions of the CVP. The long-term fault signal 142 is thus optionally used to diagnose overall health of the CVP based on the observed performance over time. In the absence of a long-term adaptive diagnostic monitor, the long-term adaptive command signal 124 continue to increase with no indication available in the short-term functions until the onset of gross slip brought about by inability to transmit torque. Thus, the long-term fault signal 142 is optionally used as a predictive monitor to diagnose the health of the CVP prior to the onset of gross slip. In some embodiments, the long-term fault signal 142 is used as an input signal into a torque remediation strategy (executed by the transmission control module 104) to reduce the likelihood of sudden gross slip. In some embodiments, the long-term fault signal 142 is optionally configured to enhance rationality diagnostics for sensors such as the CVP position sensor. For example, the rationality diagnostic is configured to compare the measured CVP position signal to the measure speed ratio to determine if the sensor reading is within an expected range of values.

It should be noted that the description above has provided dimensions for certain components or subassemblies. The mentioned dimensions, or ranges of dimensions, are provided in order to comply as best as possible with certain legal requirements, such as best mode. However, the scope of the preferred embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the embodiments should not be taken to imply that the terminology is being re-defined herein to be restricted to including any specific characteristics of the features or aspects of the preferred embodiments with which that terminology is associated.

While preferred embodiments of the present embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein could be employed in practicing the embodiments. It is intended that the following claims define the scope of the preferred embodiments and that methods and structures within the scope of these claims and their equivalents be covered thereby.

What is claimed is:

1. A computer-implemented system for a vehicle having an engine coupled to a continuously variable transmission having a ball-planetary variator (CVP), the computer-implemented system comprising:
a digital processing device comprising an operating system configured to perform executable instructions and a memory device;
a computer program including instructions executable by the digital processing device to create an application comprising a software module configured to manage a plurality of vehicle driving conditions; and
a plurality of sensors configured to monitor vehicle parameters comprising:
CVP speed ratio,
CVP input torque,
CVP position,
wherein the software module is configured to execute a ratio-to-position adaptive control sub-module, wherein the ratio-to-position adaptive control sub-module includes a first ratio-to-position calibration table configured to store values of a CVP position based at least in part on the CVP input torque and the CVP speed ratio.

2. The computer-implemented system of claim 1, wherein the ratio-to-position adaptive control sub-module further comprises an adaptive ratio control enabled sub-module configured to determine a short-term adaptive control enabled signal and a long-term adaptive control enabled signal based at least in part on the CVP position.

3. The computer-implemented system of claim 2, wherein the ratio-to-position adaptive control sub-module further comprises a second ratio-to-position calibration table configured to determine a torque index signal based at least in part on the CVP input torque.

4. The computer-implemented system of claim 3, wherein the first ratio-to-position calibration table is configured to determine a ratio index signal based at least in part on the CVP speed ratio.

5. The computer-implemented system of claim 4, wherein the ratio-to-position adaptive control sub-module further comprises a short-term adaptive control calibration map.

6. The computer-implemented system of claim 5, wherein the ratio-to-position adaptive control sub-module further comprises a long-term adaptive control calibration map.

7. The computer-implemented system of claim 6, wherein the ratio-to-position adaptive control sub-module further comprises a short-term ratio to position control sub-module configured to determine a short-term adaptive command signal.

8. The computer-implemented system of claim 7, wherein the ratio-to-position adaptive control sub-module further comprises a long-term ratio to position control sub-module configured to determine a long-term adaptive command signal.

9. The computer-implemented system of claim 8, wherein the ratio-to-position adaptive control sub-module further comprises an adaptive ratio control diagnostics sub-module.

10. The computer-implemented system of claim 9, wherein the adaptive ratio control diagnostics sub-module is configured to determine a short-term fault signal based at least in part on the short-term adaptive command signal.

11. The computer-implemented system of claim 10, wherein the adaptive ratio control diagnostics sub-module is configured to determine a long-term fault signal based at least in part on the long-term adaptive command signal.

12. The computer-implemented system of claim 10, wherein the short-term fault signal is indicative of a slip condition of the CVP.

13. The computer-implemented system of claim 11, wherein the long-term fault signal is indicative of a slip condition of the CVP.

14. The computer-implemented system of claim 7, wherein the short-term ratio to position control sub-module further comprises an adaptive function block.

15. The computer-implemented system of claim 8, wherein the long-term ratio to position control sub-module further comprises an adaptive function block.

16. The computer-implemented system of claim 14, wherein the short-term ratio to position control sub-module further comprises a write data function block.

17. The computer-implemented system of claim 15, wherein the long-term ratio to position control sub-module further comprises a write data function block.

18. The computer-implemented system of claim 1, further comprising a PID sub-module configured to determine a PID command signal based at least in part on the CVP speed ratio.

19. The computer-implemented system of claim 18, wherein the ratio-to-position adaptive control sub-module is configured to determine a short-term adaptive command signal and a long-term adaptive command signal.

20. The computer-implemented system of claim 19, wherein the short-term adaptive command signal, the long-term adaptive command signal, and the PID command signal are summed to determine a ratio control signal.
